(19) United States
(12) Patent Application Publication
(10) Pub. No.: US 2024/0116121 A1
(43) Pub. Date: Apr. 11, 2024

(54) MULTI-CONFIGURATION DEBURRING REAMER

(71) Applicants: Michael F. Medina, North Hollywood, CA (US); William Morales, North Hollywood, CA (US)

(72) Inventors: Michael F. Medina, North Hollywood, CA (US); William Morales, North Hollywood, CA (US)

(21) Appl. No.: 18/484,199

(22) Filed: Oct. 10, 2023

Related U.S. Application Data
(60) Provisional application No. 63/414,791, filed on Oct. 10, 2022.

(51) Int. Cl. B23D 77/14; B23B 5/16

(52) U.S. Cl. CPC B23D 77/14; B23B 5/167

(57) ABSTRACT

A deburring reamer device comprising a main body. The main body may comprise a first end and a second end. The first end may comprise a right-angle bend and a hole at a tip of the first end. The right angle bend may allow for pipes near studs or in hard-to-reach places to be reached by the device. The device may further comprise a rotation component disposed within the main body coupled to the hole. The device may further comprise a blade removably disposed in the hole of the main body. The blade may be configured to fit into the rotation component. The device may further comprise an actuator disposed on a surface of the main body, operatively coupled to the rotation component. Actuating the actuator may cause the rotation component to rotate the blade.

### CROSS-REFERENCES TO RELATED APPLICATIONS

This application is a non-provisional and claims benefit of the U.S. Patent Application No. 63/414,791, filed Oct. 10, 2022, the specification of which is incorporated herein in its entirety by reference.

### FIELD OF THE INVENTION

The present invention is directed to a deburring tool configured to deburr pipes at a plurality of different angles.

### BACKGROUND OF THE INVENTION

Pipe cutting, or pipe profiling, is a mechanized industrial process that removes material from a pipe or tube to create the desired profile. When pipes are cut down, burrs may occur which leave jagged edges on the inside and the outside of the pipe. It's important to remove all burrs on both sides of the pipe because they will affect how the pipe attaches to fittings and cause leaks in the plumbing system. Furthermore, deburring eliminates sharp edges so that the worker can handle it without the possibility of getting cut or injured because of it. To meet plumbing standards, all pipes must be deburred after being cut.

To this end, several methods exist for deburring pipes. While rough tools, such as files and sandpaper, can be used to deburr pipes, this tends to be time-consuming and inefficient. Several reamer tools exist for removing burrs from the inside of a pipe with just the push of a button. However, the standard configuration of reamer tools makes reaching pipes near studs or other hard-to-reach places incredibly difficult. Thus, there exists a present need for a deburring reamer device capable of deburring pipes in hard-to-reach places.

### BRIEF SUMMARY OF THE INVENTION

It is an objective of the present invention to provide devices that allow for deburring pipes in hard-to-reach places, as specified in the independent claims. Embodiments of the invention are given in the dependent claims. Embodiments of the present invention can be freely combined with each other if they are not mutually exclusive.

The present invention features a deburring reamer device comprising a main body. The main body may comprise a first end and a second end. The first end may comprise a right-angle bend and a hole at a tip of the first end. The right angle bend may allow for pipes near studs or in hard-to-reach places to be reached by the device. The device may further comprise a rotation component disposed within the main body coupled to the hole. The device may further comprise a blade removably disposed in the hole of the main body. The blade may be configured to fit into the rotation component. The device may further comprise an actuator disposed on a surface of the main body, operatively coupled to the rotation component. Actuating the actuator may cause the rotation component to rotate the blade.

One of the unique and inventive technical features of the present invention is the implementation of a deburring device having an angled end. Without wishing to limit the invention to any theory or mechanism, it is believed that the technical feature of the present invention advantageously provides for the deburring of pipes near studs or in other hard-to-reach places. None of the presently known prior references or work has the unique inventive technical feature of the present invention.

Another one of the unique and inventive technical features of the present invention is the implementation of a dual-configuration deburring device having an angled end and a straight end. Without wishing to limit the invention to any theory or mechanism, it is believed that the technical feature of the present invention advantageously provides for a variety of reamer configurations for the deburring of pipes in a variety of locations. None of the presently known prior references or work has the unique inventive technical feature of the present invention.

Any feature or combination of features described herein is included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWING(S)

The features and advantages of the present invention will become apparent from a consideration of the following detailed description presented in connection with the accompanying drawings in which:

FIG. 1 shows an isometric view of the deburring reamer of the present invention.

FIG. 2A shows a side view of the deburring reamer of the present invention with blades attached.

FIG. 2B shows multiple side views of the deburring reamer with blades detached.

FIG. 3 shows a deconstructed view of the deburring reamer of the present invention.

FIG. 4 shows the deburring reamer of the present invention shown to scale with a human hand.

FIG. 5 shows the deburring reamer of the present invention in use.

FIG. 6 shows the deburring reamer of the present invention disassembled into halves, showing the internal pillar and wall reinforcements for connecting the halves of the body together.

### DETAILED DESCRIPTION OF THE INVENTION

Following is a list of elements corresponding to a particular element referred to herein:
100 device
110 body
111 first end
112 second end
120 rotation component
131 first blade
132 second blade
140 actuator
150 storage
160 release button

The term “reamer” is defined herein as a type of rotary cutting tool used in metalworking, configured to enlarge the size of a hole by a small amount to leave smooth edges and sides.

The term “debur” is defined herein as neatening and smoothing the rough edges or ridges of an object. In an exemplary embodiment, deburring a tube or pipe may comprise smoothing the end of the pipe. For example, a metal pipe can have sharp edges at its cut end. Deburring the cut metal pipe involves removing the sharp edges by cutting out or shaving pieces of the metal.

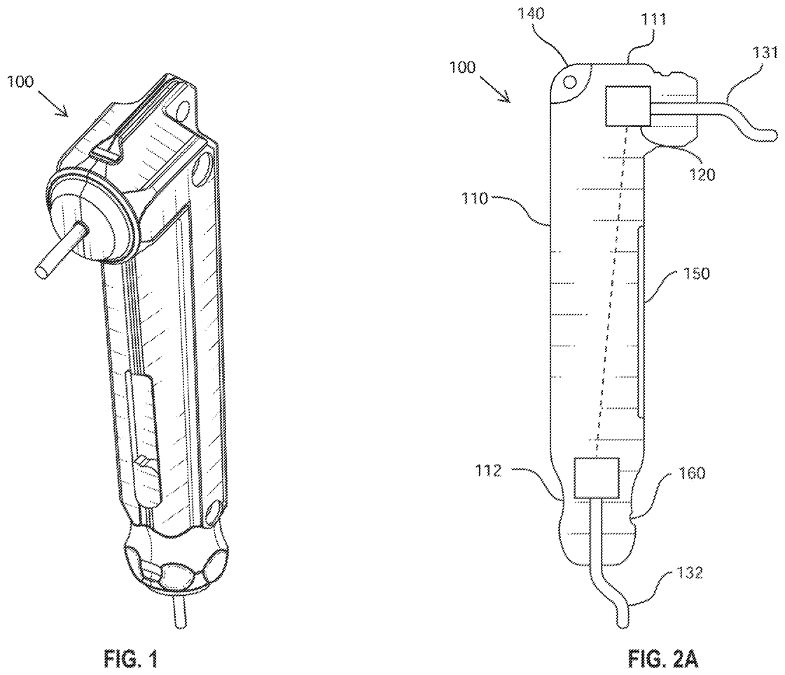

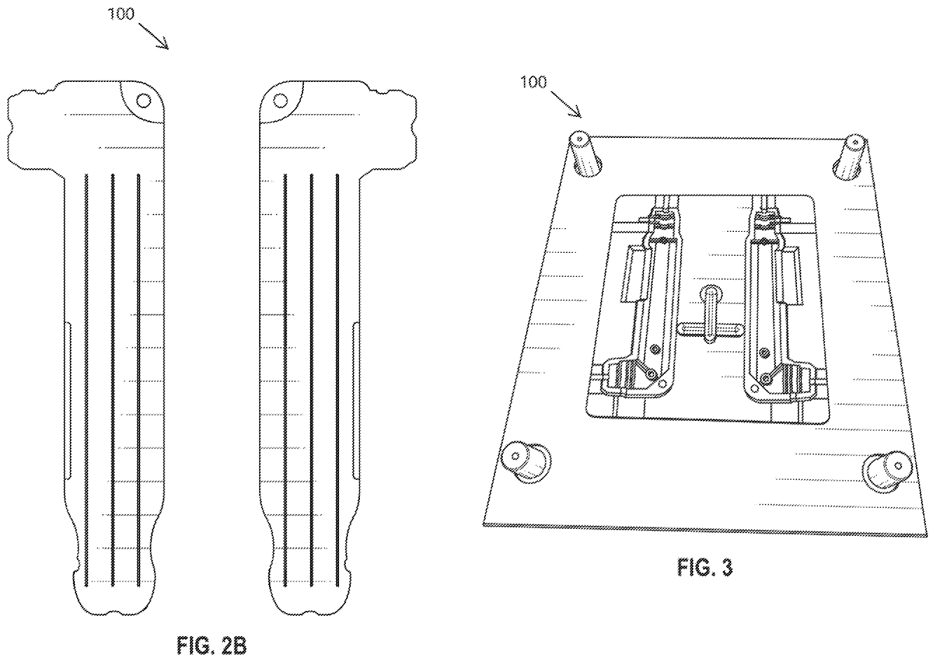

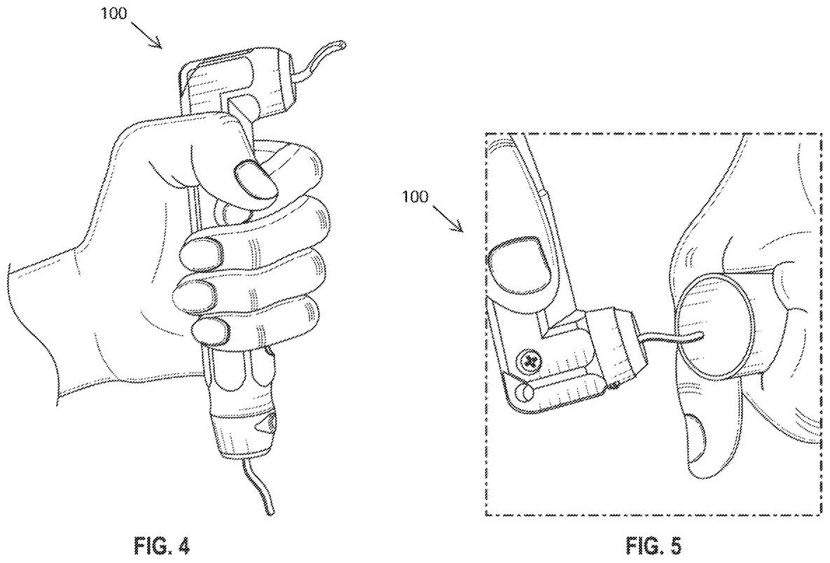

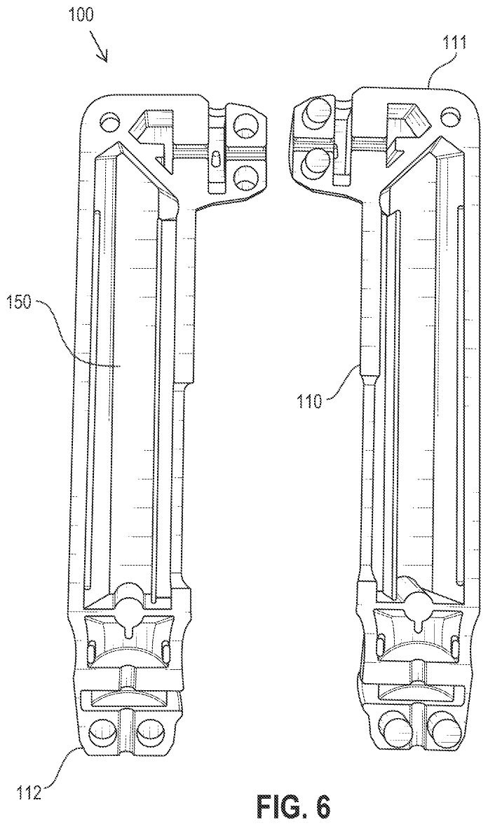

Referring now to FIGS. 1-6, the present invention features a deburring reamer device (100) comprising a main body (110). The main body (110) may comprise a first end (111) and a second end (112). The first end (111) may comprise an angled bend and a hole at a tip of the first end (111). The angled bend may allow for pipes near studs or in hard-to-reach places to be reached by the device (100). The device (100) may further comprise a rotation component (120) disposed within the main body (110) coupled to the hole. The device (100) may further comprise a blade (131) removably coupled to the rotation component (120), extending through the hole of the main body (110). The device (100) may further comprise an actuator (140) disposed on a surface of the main body (110), operatively coupled to the rotation component (120). Actuating the actuator (140) may cause the rotation component (120) to rotate the blade (131).

The present invention features a deburring reamer device (100) comprising a main body (110) comprising a first end (111) and a second end (112). The first end (111) may comprise a right-angle bend and a first hole at a tip of the first end (111). The second end (112) may comprise a second hole at a tip of the second end (112). The second end has a straight angle to deburr pipes in easy-to-reach places. The device (100) may further comprise a rotation component (120) disposed within the main body (110) coupled to the first hole and the second hole. The device (100) may further comprise a first blade (131) removably coupled to the rotation component (120), extending through the first hole of the main body (110). The device (100) may further comprise a second blade (132) removably coupled to the rotation component (120), extending through the second hole of the main body (110). The device (100) may further comprise an actuator (140) disposed on a surface of the main body (110), operatively coupled to the rotation component (120). Actuating the actuator (140) may cause the rotation component (120) to rotate the first blade (131) and the second blade (132).

In some embodiments, the actuator (140) comprises a button. In some embodiments, the button comprises a resin material. In some embodiments, the resin material may comprise polypropylene, polyethylene, an epoxy, any other resin material, or a combination thereof. In some embodiments, the main body (110) comprises a plastic material. In some embodiments, the plastic material may comprise polycarbonate, polyethylene, polypropylene, polymethyl methacrylate, polyethylene terephthalate, polyvinyl chloride, any other plastic material, or a combination thereof.

In some embodiments, the first blade (131), the second blade (132), or a combination thereof may comprise a metal material. In some embodiments, the metal material may comprise steel, copper, silver, any metallic material, or a combination thereof. In some embodiments, the device (100) may further comprise a storage container (150) disposed in the main body (110), the storage container (150) comprising a storage door disposed on the surface of the main body (110). In some embodiments, the device (100) may further comprise a release button (160) disposed on the surface of the main body (110), operatively coupled to the rotation component (120). Actuating the release button (160) may cause the first blade (131), the second blade (132), or a combination thereof to be removed from the rotation component (120). In some embodiments, the device (100) may further comprise a power source selected from a group comprising a battery pack, a wired connection to an external power source, a wireless connection to a wireless charging component, or a combination thereof. In some embodiments, the blades may be able to be pushed back into their respective holes while they are not currently rotating.

In some embodiments, the main body (110) may comprise a first half and a second half, such that the separation between the first half and the second half is a vertical seam along the length of the main body (110). In some embodiments, the separation between the first half and the second half is a seam in any configuration around a diameter of the main body (110).

In some embodiments, the first half and the second half may be connected by a pillar reinforcement system disposed within the main body (110). In some embodiments, the pillar reinforcement system may comprise one or more pillars disposed within the first half, the second half, or a combination thereof, and one or more slots disposed within the first half, the second half, or a combination thereof, such that each pillar in the first half aligns with a slot in the second half and each pillar in the second half aligns with a slot in the first half. Each pillar may be configured to snugly fit into its corresponding slot such that the first half and the second half can be fitted together by fitting each pillar into its corresponding slot.

In some embodiments, the one or more pillars and the one or more slots may comprise a circular shape, a square shape, a triangular shape, or any other shape. In some embodiments, the one or more pillars and the one or more slots may be disposed at the first end (111), the second end (112), or a combination thereof. In some embodiments, the one or more pillars and the one or more slots may be disposed at any point within the main body (110). In some embodiments, the device (100) may comprise 2 to 10 pillars and slots. In some embodiments, the device (100) may comprise 4 pillars and slots. In some embodiments, the device (100) may comprise 2 or more pillars and slots.

In some embodiments, the walls at the angled bend of the main body (110) may be reinforced by extra material such that the bend has greater strength. In some embodiments, the walls may be reinforced with one or more reinforcement components. In some embodiments, the angled bend comprises a 25 to 120 degree angle. In some embodiments, the angled bend comprises a 45 degree angle. In some embodiments, the angled bend comprises a 90 degree angle.

In some embodiments, the first blade (131), the second blade (132), or a combination thereof may comprise a tilted edge, a curved edge, a straight edge, or a combination thereof (i.e. a straight portion leading into a curved/tilted portion). In some embodiments, the first blade (131), the second blade (132), or a combination thereof may comprise a tilted edge comprising a 30 to 85 degree angle. In some embodiments, the first blade (131), the second blade (132), or a combination thereof may comprise a tilted edge comprising a 45 degree angle.

In some embodiments, the device (100) may comprise two rotation components, such that a first rotation component is operatively coupled to the first blade (131) and a second rotation component is operatively coupled to the second blade (132). In some embodiments, the first rotation component may be configured to rotate the first blade (131) when actuated and the second rotation component may be configured to rotate the second blade (132) when actuated.

In some embodiments, the device (100) of the present invention comprises a length of 10 to 20 inches. In some embodiments, the device (100) of the present invention comprises a diameter of 2 to 4 inches.

Referring now to FIG. 5, in some embodiments, the deburring reamer device (100) of the present invention may be used to debur a pipe. In a non-limiting embodiment, the method of deburring a pipe may comprise providing the deburring reamer device (100), inserting a blade of the device into the pipe, applying pressure between the blade and an interior wall of the pipe, and rotating the tilted blade around the interior wall of the pipe to debur the pipe.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A deburring reamer device (100) comprising:
a. a main body (110) comprising an angled bend leading to a tip comprising a hole;
b. a blade (131) disposed within the main body (110), extending through the hole; and
c. a rotation component (120) disposed within the main body (110), operatively coupled to the blade (131), configured to rotate the blade (131) upon actuation.

2. A deburring reamer device (100) comprising:
a. a main body (110) comprising a right-angle bend leading to a tip comprising a hole;
b. a rotation component (120) disposed within the main body (110);
c. a blade (131) removably coupled to the rotation component (120), extending through the hole of the main body (110); and
d. an actuator (140) disposed on a surface of the main body (110), operatively coupled to the rotation component (120);
wherein actuating the actuator (140) causes the rotation component (120) to rotate the blade (131).

3. The device (100) of claim 2, wherein the actuator (140) comprises a button.

4. The device (100) of claim 3, wherein the button comprises a resin material.

5. The device (100) of claim 2, wherein the main body (110) comprises a plastic material.

6. The device (100) of claim 2, wherein the blade (131) comprises a metal material.

7. The device (100) of claim 2 further comprising a storage container (150) disposed in the main body (110), and the storage container (150) comprising a storage door disposed on the surface of the main body (110).

8. The device (100) of claim 2 further comprising a release button (160) disposed on the surface of the main body (110), operatively coupled to the rotation component (120), wherein actuating the release button (160) causes the blade (131) to be removed from the rotation component (120).

9. The device (100) of claim 2 further comprising a power source selected from a group comprising a battery pack, a wired connection to an external power source, or a combination thereof.

10. A deburring reamer device (100) comprising:
a. a main body (110) comprising a first end (111) and a second end (112);
wherein the first end (111) comprises a right-angle bend and a first hole at a tip of the first end (111);
wherein the second end (112) comprises a second hole at a tip of the second end (112);
b. a rotation component (120) disposed within the main body (110);
c. a first tilted blade (131) removably coupled to the rotation component (120), extending through the first hole of the main body (110);
d. a second tilted blade (132) removably coupled to the rotation component (120), extending through the second hole of the main body (110); and
e. an actuator (140) disposed on a surface of the main body (110), operatively coupled to the rotation component (120);
wherein actuating the actuator (140) causes the rotation component (120) to rotate the first tilted blade (131) and the second tilted blade (132).

11. The device (100) of claim 10, wherein the actuator (140) comprises a button.

12. The device (100) of claim 11, wherein the button comprises a resin material.

13. The device (100) of claim 10, wherein the main body (110) comprises a plastic material.

14. The device (100) of claim 10, wherein the first tilted blade (131) and the second tilted blade (132) comprise a metal material.

15. The device (100) of claim 10 further comprising a storage container (150) disposed in the main body (110), the storage container (150) comprising a storage door disposed on the surface of the main body (110).

16. The device (100) of claim 10 further comprising a release button (160) disposed on the surface of the main body (110), operatively coupled to the rotation component (120), wherein actuating the release button (160) causes the first tilted blade (131), the second tilted blade (132), or a combination thereof to be removed from the rotation component (120).

17. The device (100) of claim 10 further comprising a power source selected from a group comprising a battery pack, a wired connection to an external power source, or a combination thereof.

18. The device (100) of claim 10, wherein the main body (110) comprises a first half and a second half connected by a pillar reinforcement system disposed within the main body (110), wherein a separation between the first half and the second half comprises a seam along a length of the main body (110).

19. The device (100) of claim 18, wherein the pillar reinforcement system comprises one or more pillars disposed in the first half, the second half, or a combination thereof, and one or more slots disposed in the first half, the second half, or a combination thereof, such that each pillar disposed in the first half is configured to fit into a slot disposed in the second half and each pillar disposed in the second half is configured to fit into a slot disposed in the first half.

20. A method of deburring a pipe, comprising:
a. providing the deburring reamer device (100) of claim 10;
b. inserting one of the tilted blades into the pipe;
c. applying pressure between the tilted blade and an interior wall of the pipe; and
d. rotating the tilted blade around the interior wall of the pipe to debur the pipe.
